(19) United States
(12) Patent Application Publication
(10) Pub. No.: US 2006/0195979 A1
(43) Pub. Date: Sep. 7, 2006

(54) Foot sauna & massage tank

(76) Inventor: Minggao Liu, Dongguan (CN)

Correspondence Address: Mr. Eric Chan, 42 Pin Oaks Drive, Phoenixville, PA, 19460, US

(21) Appl. No.: 11/072,433

(22) Filed: Mar. 7, 2005

(51) Int. Cl. A61H 33/06

(52) U.S. Cl. 4/535

(57) ABSTRACT

This invention belongs to health-care equipment & technology sector. It is a kind of sauna massage tank for foot health. There is a partition bearing board inside, and a chamber is formed by the partition board, the bottom and the side of the tank. There is a pipe connecting the chamber and the steam source (a sealed device). There are numerous convex points on the partition board, and there is a hole at the convex point. This utility is suitable for foot soaking and massage. It is of simple structure, low cost, convenient to use for different purposes.

### BACKGROUND OF THE INVENTION

This invention belongs to health-care equipment & technology field. It is a kind of sauna massage tank for foot health.

Foot is the part of the human body with the most acupoints. Foot massage is widely recognized as a way to keep feet healthy. Hot water soaking or foot sauna can promote the blood circulation of feet and legs, beneficial to eliminate fatigue and prevent diseases. Foot-massage gradually becomes an indispensable part in our daily life. People have adopted the old way for foot soaking: put hot water into a tank and put feet in. So this kind of experience in common: too hot at the beginning, and after some time, it cools down. The heat is uneven, temperature is not easy to control. That is why the best result for health-case and keeping-fit is difficult to be achieved.

### BRIEF SUMMARY OF THE INVENTION

This invention aims to overcome the shortcomings of the existing technologies, to offer a new kind of sauna foot tank, which is convenient for foot-soaking and massage, with temperature control system.

In order to achieve the goals, this foot sauna-message tank mainly consists of a tank body. There is a bearing board inside the tank body. A chamber is formed by the bearing board and the sides of the tank. At the bottom, there is a pipe connecting the chamber with the steam source. There are numerous convex points on the surface of the bearing board, and there are holes at the convex points, which enables smooth steam flow between the bearing board and the chamber. The tank has a cover, which has two big access holes for feet. There is foam material around the edge of the access holes at the cover.

The tank body is made of stainless steel device, placed on a heating device. There is a supplying-pipe with an attached switch beside the tank.

The tank has temperature display and temperature control switch. The tank has a filling opening for hot and cold water, with drainage pipe.

It is of simple structure, low cost, convenient to use for different purposes.

### BRIEF DESCRIPTION OF THE DRAWINGS

FIG. 1 is a structural figure of the invention.

FIG. 2 is a structural figure of the bearing board in this invention.

### DETAILED DESCRIPTION OF THE INVENTION

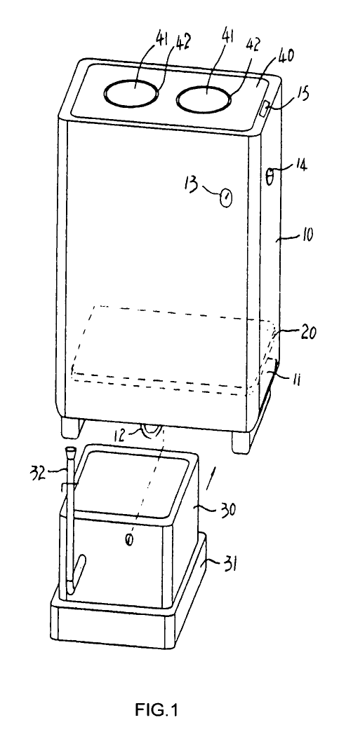

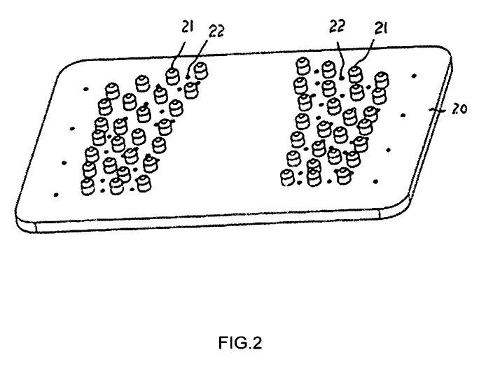

Shown as FIG. 1 and FIG. 2, this invention mainly has an empty tank 10, with a bearing board 20 inside. The four sides of tank 10 and bearing board 20 will form a chamber 11, which will be connected to a sealed steam container 30 for the use of steam supply through a conduit 12. There're convex points 21 on the upper side of the bearing board 20, and small holes 22 are set among such convex points to connect with the chamber 11 below. The tank 10 has a cover 40. Two big holes 41 with soft foam 42 covered on the edge are set on the cover 40 for feet to enter in.

The container 30 is made of stainless steel. Under container 30 is a heater 31. A pipe 32 with switch 32(1) on for injecting herbal material is connected to the container 30. An induction cooker can work as a heater 31, whose function is heating the container 30, while some liquid medicine can be poured into the container 30 through pipe 32.

A thermometer 13 and a temperature adjustment switch 14 are installed on the tank 10.

Users can monitor the inner temperature of tank 10 through the thermometer 13, and control the steam inside through the temperature adjustment switch 14 per their own requirements.

The tank 10 is also furnished with an injection hole 15, and on the bottom of which there is a bleed hole. When massaging the feet, hot water can be injected into the tank through hole 15, in the meanwhile injecting cold water to mix the temperature.

When using this invention, users can put feet in through the big hole 41 on the cover 40. The soft foam 42 around the edge of 41 will protect the feet and prevent the steam from escaping. Just step on the convexities 21 rising from the bearing board 20, whose round tip will support and massage the feet effectively. Heater 31 will heat the water or liquid medicine in the container 30 to boil point and produce steam, which can be transferred into the chamber 11 under the bearing board 20 through the conduit 12 between container 30 and chamber 11. Then the steam sprays out through the small holes on the bearing board 20, to fumigate the bottom of feet for the purpose of massaging, relaxing and releasing the fatigue. During the steam staying in the tank 10 and fumigating the feet, sweat pores will fully open and rapidly absorb the medicine to achieve the wonderful effect of feet care and treatment.

This invention is of simple structure and low cost, for the purpose of household, service and medical use. It has wonderful effect of the foot health care.

As to a further discussion of the manner of usage and operation of the present invention, the same should be apparent from the above description. Accordingly, no further discussion relating to the manner of usage and operation is provided.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

The present invention is capable of other embodiments and of being practiced and carried out in various ways. It is to be understood that the phraseology and terminology employed herein are for the purpose of description and should not be regarded as limiting.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to falling within the scope of the invention.

What is claimed is:

1. A foot sauna-message tank mainly consists of a tank body. There is a bearing board inside the tank body. A chamber is formed by the bearing board and the sides of the tank. At the bottom, there is a pipe connecting the chamber with the steam source. There are numerous convex points on the surface of the bearing board, and there are holes at the convex points, which enables smooth steam flow between the bearing board and the chamber. The tank has a cover, which has two big access holes for feet.

2. A foot sauna-message tank as in claim 1, wherein there is foam material around the edge of the access holes at the cover.

3. A foot sauna-message tank as in claim 1, wherein the tank body is made of stainless steel device, placed on a heating device. There is a supplying-pipe with an attached switch beside the tank.

4. A foot sauna-message tank as in claim 1, wherein the tank has temperature display and temperature control switch.

5. A foot sauna-message tank as in claim 1, wherein the tank has a filling opening for hot and cold water, with drainage pipe.
